(19) United States
(12) Patent Application Publication
(10) Pub. No.: US 2004/0068822 A1
(43) Pub. Date: Apr. 15, 2004

(54) Windshield wiper spoiler fixture

(76) Inventor: Robert Leu, Taipei (TW)

Correspondence Address: Robert Leu, PO Box 82-144, Taipei, TW

(21) Appl. No.: 10/267,882

(22) Filed: Oct. 10, 2002

(51) Int. Cl. B60S 1/38

(52) U.S. Cl. 15/250.201; 15/250.44

(57) ABSTRACT

A fixture for easy assembly of a spoiler to a windshield wiper comprised of a spoiler, and a pair of locking pieces, each in an inverted U-shape and extending backward from the back of the spoiler; a long protrusion at the center of a recessed surface of the locking piece; a hook each protruding from the inner edge of each of both vertical portions of the locking piece; both hooks locking onto an articulation of a wiper; and both protrusions being inserted into slot in the articulation to secure the spoiler in position.

### BACKGROUND OF THE INVENTION

(a) Field of the Invention

The present invention is related to a fixture, and more particularly, to one which allows easy assembly of a spoiler to a windshield wiper.

(b) Description of the Prior Art:

It has been found that a spoiler is mounted to a windshield wiper either by having made the spoiler an integrated part with the wiper or by means of a fixation plate provided with screw hole in it to lock the spoiler with a screw penetrating through the screw hole, and then into a long slot of an articulation of the wiper before being tightened up with a nut to secure the spoiler in position. The long nature of the slot in the articulation of the wiper makes the assembly work difficult, resulting in longer man-hour and production costs; and it becomes even more difficult if the consumer has to do the assembly all by himself. That could affect the sales of the product.

### SUMMARY OF THE INVENTION

The primary purpose of the present invention is to provide an easy means to fix the spoiler to the windshield wiper to promote the practical value of the spoiler. To achieve the purpose, a pair of locking pieces each indicating an inverted U-shape and arranged in symmetry extending backward from the upper edge in the back of the spoiler and a long protrusion each provided at the center of a recessed surface of the locking piece while a protruded hook is each provided on the inner edge of two vertical portions of the locking piece. By having the hooks to respectively lock onto the articulation of the wiper with both protrusions inserted into the long slot of the articulation for the spoiler to be secured in front of the wiper.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1 is a perspective view of a preferred embodiment of the present invention.

FIG. 2 is a perspective view of a locking piece of the preferred embodiment of the present invention.

FIG. 3 is a schematic view of the preferred embodiment of the present invention as assembled.

FIG. 4 is a sectional view of the assembly of the embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

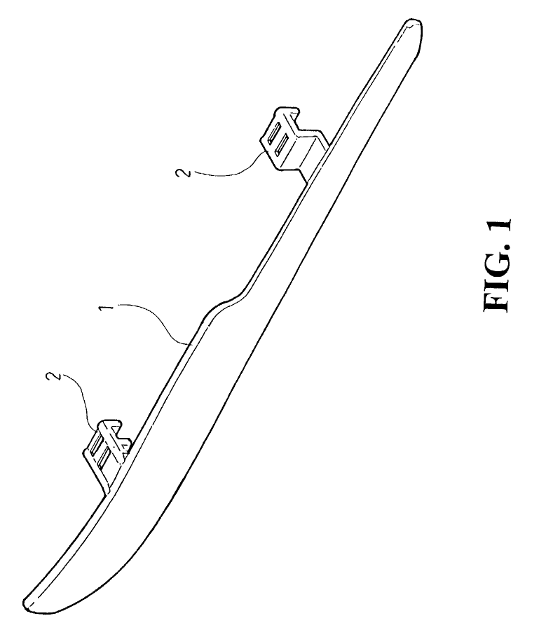

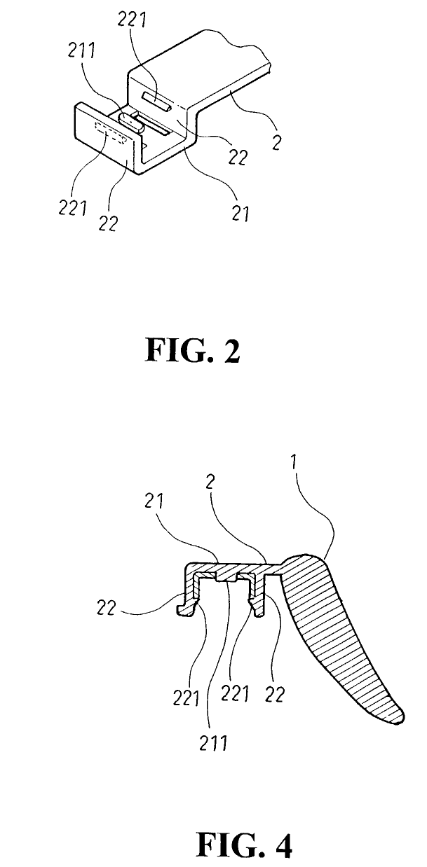

Referring to FIGS. 1 and 2, a preferred embodiment of the present invention is comprised of a spoiler 1, and a pair of locking pieces each generally indicating an inverted U-shape, and extending backward in symmetry from the upper edge in the back of the spoiler 1. Wherein, a long protrusion 211 is provided from the center of the bottom of a recessed surface 21 of each locking piece 2, and two vertical portions 22 of the locking piece 2 have each respectively provided at its inner edge a protruded hook 221 to lock onto an articulation 31 of a wiper 3 while each of both protrusions 211 are inserted into slot in the articulation 31 upon assembling the spoiler 1. As the spoiler 1 is fixed in front of the wiper 3 and secured in position by both of the protrusion 211, the spoiler 1 helps stabilize the operation of the wiper 3 and makes easier assembly of the spoiler 1.

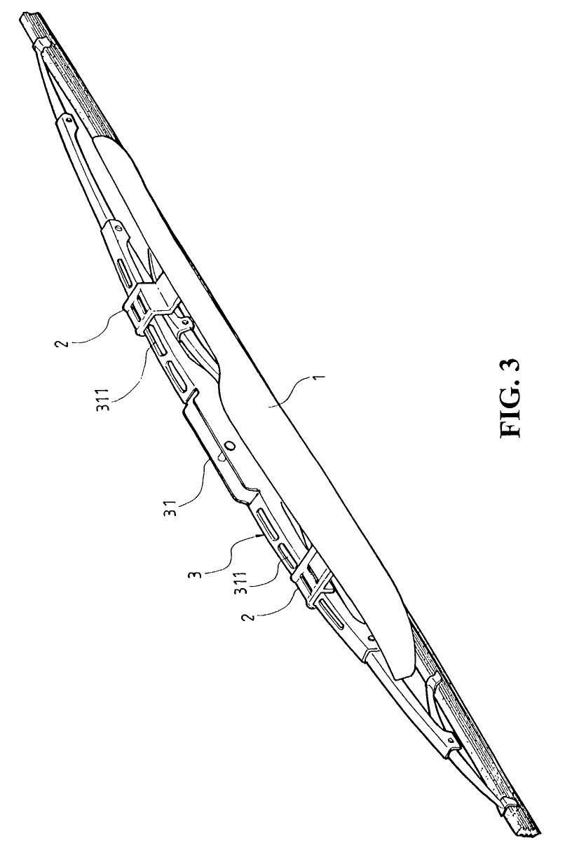

Now referring to FIGS. 3 and 4 for an assembly of the preferred embodiment. Wherein, both hooks 221 provided to the vertical portions 22 of each locking piece 2 of the spoiler 1 are respectively locking onto the bottom edges on both side of the articulation 31 of a wiper 3 for the locking piece 1 to be embodied in the articulation 31 while both protrusions 211 from the recessed surface 21 of the locking piece 2 are inserted into the slot 311 of the articulation 31. As a result, the articulation 31 is retained by both hooks 221 and secured in position since both hooks 221 are also caulked into the slot 311 to avoid improper slide of the spoiler 1 for improved performance of the spoiler 1. Furthermore, easy assembly of the spoiler 1 by simply hooking and insertion 1 further improves the practical value of the spoiler 1.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A windshield wiper spoiler fixture is essentially comprised of a spoiler, and a pair of locking pieces, each generally indicating an inverted U-shape and extending backward from the upper edge in the rear of the spoiler; a long protrusion at the center of a recessed surface of the locking piece; a hook each protruding from the inner edge of each of both vertical portions of the locking piece; both hooks locking onto an articulation of a wiper; and both protrusions being inserted into slot in the articulation to secure the spoiler in position.
